(19) United States
(12) Patent Application Publication
(10) Pub. No.: US 2018/0342198 A1
(43) Pub. Date: Nov. 29, 2018

(54) PIXEL CIRCUIT, DRIVING METHOD AND DISPLAY

(71) Applicant: EverDisplay Optronics (Shanghai) Limited, Shanghai (CN)

(72) Inventor: Xingyu ZHOU, Shanghai (CN)

(73) Assignee: EverDisplay Optronics (Shanghai) Limited, Shanghai (CN)

(21) Appl. No.: 15/986,124

(22) Filed: May 22, 2018

(30) Foreign Application Priority Data
May 23, 2017 (CN) 201710369256.3

(51) Int. Cl. G09G 3/32

(52) U.S. Cl. CPC G09G 3/32; G09G 2320/0233; G09G 2320/045; G09G 2300/043; G09G 2300/0842; G09G 2330/02; G09G 2300/0426; G09G 2300/0819

(57) ABSTRACT

A pixel circuit, a driving method and a display is provided. The pixel circuit comprises a compensation unit which includes a data strobe transistor and a compensation transistor, wherein a first electrode of the data strobe transistor is coupled to a second electrode of the compensation transistor; a first electrode of the compensation transistor is coupled to a gate electrode of the compensation transistor, the gate electrode thereof is coupled to a driving unit through a first node; an external power supply, the driving unit and a light-emitting unit are sequentially coupled in series; a capacitor is located between the first node and the external power supply; the driving unit generates a driving current to drive the light-emitting unit to emit light; a driving transistor of the driving unit shares a same gate electrode with the compensation transistor.

### CROSS REFERENCE

This application is based upon and claims priority to Chinese Patent Application No. 201710369256.3, filed on May 23, 2017, the entire contents thereof are incorporated herein by reference.

### TECHNICAL FIELD

The present disclosure relates to the technical field of electronic display, particularly to a pixel circuit, a driving method and a display.

### BACKGROUND

In an existing pixel circuit, generally, a thin film transistor (TFT) is utilized to drive a light-emitting diode (LED) in the pixel circuit to emit light. Such a TFT is referred to as a driving transistor. The driving transistor operates at a saturation state, because a driving current output by the driving transistor at the saturation state is less sensitive to a source-drain voltage than that of the driving transistor at a linear state and can provide the LED with more stable driving current. FIG. 1 illustrates a basic pixel circuit in the related art. As illustrated in FIG. 1, the pixel circuit is consisted of one capacitor C11 and two transistors T11, T12. When a signal Sn controls the transistor T12 to be turned on, a data signal data is written into a node N1 to charge the capacitor C11 and meanwhile drive the driving transistor T11 to be turned on. A driving current generated by T11 allows a LED EL11 located between a first power supply ELVDD and a second power supply ELVSS to emit light. The driving current I_{EL} can be expressed by an Equation I as below:

$${I}_{EL} = \frac{1}{2} μ {C}_{OX} \frac{W}{L} {( {V}_{GS} + {V}_{TH} )}^{2} \qquad ( Equation I )$$

wherein μ indicates a carrier mobility, C_{OX} indicates a gate-oxide capacitance per unit area, L indicates a channel length of T11, W indicates a gate width of T11, V_{GS} indicates a gate voltage of T11, and V_{TH}, indicates a threshold voltage of T11. As can be seen from the Equation 1, a magnitude of the driving current is relevant to the threshold voltage of T11. However, due to the existence of a threshold shift phenomenon, the threshold voltage of the driving transistor T11 is not stable, which further results in a drift of the driving current and an uneven brightness of the LED.

In order to solve the above problems, a series of circuits have been proposed, which are referred to as threshold compensation circuits, for eliminating an influence resulted by the threshold shift of the driving transistor. FIG. 2 illustrates an existing threshold compensation circuit. As illustrated in FIG. 2, during a data writing stage, transistors T22 and T23 are turned on by a signal Sn, which leads to to a short circuit between a gate electrode and a drain electrode of the driving transistor T21. At the same time, a transistor T25 is turned off by a signal En, a transistor T24 is turned off by a signal Sn−1, and a data signal “data” is input into the drain electrode of T21 through T22. At this time, due to the short circuit between the gate electrode and the drain electrode of T21, the data signal is transmitted to the gate electrode through the drain electrode of T21, and a capacitor C21 begins to store electric charges so that a gate voltage of T22 is gradually decreased to a value of (V_{data}+V_{TH}). Then, T21 is cut-off, and C21 stops charging. During a light-emitting stage, the signal En drives the transistor T25 to be turned on, the signal Sn−1 turns off the transistor T24, the signal Sn turns off the transistors T22 and T23, and a power supply ELVDD is transmitted to the transistor T21 through the transistor T25. At this time, a driving current generated by the driving transistor can be expressed by an Equation II as below:

$${I}_{EL} = \frac{1}{2} μ {C}_{OX} \frac{W}{L} {( {V}_{ELVDD} - {V}_{data} )}^{2} . \qquad ( Equation II )$$

As can be seen from the Equation II, the magnitude of the driving current is no longer relevant to the threshold voltage of the driving transistor T21.

However, in the existing threshold compensation circuit represented by FIG. 2, during the data writing stage, the power supply ELVDD and the data signal are only spaced by the transistor T25. Due to the fact that the voltage of the power supply ELVDD is much higher than that of other signals, and also due to the existence of a leakage current in T25, the data signal tends to be influenced by the power supply ELVDD, which in turn influences an luminous stability of the LED. In addition, the circuit is consisted of multiple transistors with complex structure and relatively higher cost.

As above, the problems in the related art involves that the luminance of the LED is unstable and the circuit structure thereof is complex.

### SUMMARY

The present disclosure provides a pixel circuit, a driving method and a display to solve the problems in the existing technology that the luminance of the LED is unstable and the circuit structure is complex.

An embodiment of the present disclosure provides a pixel circuit, including a compensation unit, a driving unit, a light-emitting unit, a capacitor and an external power supply. The compensation unit includes a data strobe transistor and a compensation transistor.

In the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor, the gate electrode of the compensation transistor is electrically connected to the driving unit through a first node; the external power supply, the driving unit and the light-emitting unit are sequentially connected in series; the capacitor is located between the first node and the external power supply.

The compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit.

The capacitor is configured to maintain the voltage of the first node at the first voltage.

The driving unit is externally connected to a first control signal and is configured to generate a driving current according to the first control signal so as to drive the light-emitting unit to emit light; the driving current is obtained according to the first voltage, the external power supply and a threshold voltage of a driving transistor in the driving unit; the driving transistor and the compensation transistor are configured to share a same gate electrode.

Optionally, the driving transistor and the compensation transistor are mirror transistors.

Optionally, the pixel circuit further includes an initialization unit.

The initialization unit is located between the first node and the light-emitting unit; the initialization unit is externally connected to a second scanning signal and an initialization voltage.

The initialization unit is configured to initialize the first node and the light-emitting unit by utilizing the initialization voltage, under a control of the second scanning signal.

Optionally, the initialization unit includes a first initialization transistor and a second initialization transistor.

A first electrode of the first initialization transistor is externally connected to the initialization voltage; a second electrode of the first initialization transistor is electrically connected to the first node; a gate electrode of the first initialization transistor is electrically connected to the second scanning signal.

A first electrode of the second initialization transistor is externally connected to the initialization voltage; a second electrode of the second initialization transistor is electrically connected to the light-emitting unit; a gate electrode of the second initialization transistor is electrically connected to the second scanning signal.

Optionally, the driving unit includes a driving transistor and a light-emitting control transistor.

A first electrode of the driving transistor is externally connected to the external power supply; a gate electrode of the driving transistor is electrically connected to the compensation unit; a second electrode of the driving transistor is electrically connected to a first electrode of the light-emitting control transistor.

A second electrode of the light-emitting control transistor is electrically connected to the light-emitting unit, and a gate electrode of the light-emitting control transistor is externally connected to the first control signal.

Optionally, the driving unit includes a driving transistor and a light-emitting control transistor.

A first electrode of the light-emitting control transistor is externally connected to the external power supply; a second electrode of the light-emitting control transistor is electrically connected to a first electrode of the driving transistor, a gate electrode of the light-emitting control transistor is externally connected to the first control signal.

A gate electrode of the driving transistor is electrically connected to the compensation unit; a second electrode of the driving transistor is electrically connected to the light-emitting unit.

An embodiment of the present disclosure provides a driving method of a pixel circuit which is applied in the pixel circuit mentioned above.

The driving method includes: during a data writing stage, controlling the first scanning signal to turn on the data strobe transistor so that the compensation transistor sets a voltage of the first node to the first voltage; and controlling the first control signal to turn off the driving unit so that the light-emitting unit doesn't emit light; maintaining the voltage of the first node at the first voltage by the capacitor, the first voltage is a voltage obtained upon compensating for a voltage of the data signal by the compensation transistor of the compensation unit; and during a light-emitting stage, controlling the first scanning signal to turn off the data strobe transistor and controlling the first control signal to turn on the driving unit so that the driving unit generates a driving current to drive the light-emitting unit to emit light; the driving current is generated according to the first voltage, the external power supply and a threshold voltage of the driving transistor of the driving unit; the capacitor is at a maintaining state.

Optionally, before the data writing stage, the driving method further includes: during an initialization stage, controlling the second scanning signal to turn on the initialization unit so that the initialization unit initializes the first node and the light-emitting unit by utilizing an initialization voltage and the capacitor maintains the initialization voltage; controlling the first scanning signal to turn off the data strobe transistor and controlling the first control signal to turn off the driving unit.

Optionally, the driving method further includes: during the data writing stage, controlling the second scanning signal to turn off the initialization unit; and during the light-emitting stage, controlling the second scanning signal to turn off the initialization unit.

An embodiment of the present disclosure provides a display including the pixel circuit mentioned above.

To sum up, embodiments of the present disclosure provide a pixel circuit, a driving method and a display, including a compensation unit, a driving unit, a light-emitting unit, a capacitor and an external power supply. The compensation unit includes a data strobe transistor and a compensation transistor; in the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor; the gate electrode of the compensation transistor is electrically connected to the driving unit through a first node; the external power supply, the driving unit and the light-emitting unit are sequentially connected in series; the capacitor is located between the first node and the external power supply; the compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit; the capacitor is configured to maintain the voltage of the first node at the first voltage; the driving unit is externally connected to a first control signal and is configured to generate a driving current according to the first control signal so as to drive the light-emitting unit to emit light; the driving current is obtained according to the first voltage, the external power supply and a threshold voltage of a driving transistor in the driving unit; the driving transistor and the compensation transistor are configured to share a same gate electrode. The compensation unit is externally connected to the data signal, and the driving unit is externally connected to the external power supply, so that during the data writing stage, the data signal compensates for a threshold voltage of the compensation transistor of the compensation unit to increase the threshold voltage of the compensation transistor to a voltage of the data signal, so as to obtain the first voltage. The compensation unit is not externally connected to the external power supply, which avoids any influence to the data signal resulted by the external power supply. Furthermore, the driving transistor and the compensation transistor share a same gate electrode, and hence have a same variation tendency in threshold voltage; as a result, compensating for the threshold voltage of the compensation transistor as the voltage of the data signal is fairly equivalent to compensating for the threshold value of the driving transistor as the voltage of the data signal, thereby ensuring the threshold compensation function of the pixel circuit. Therefore, the embodiments of the present disclosure can achieve the threshold compensation function of the pixel circuit while preventing from any influence to the data signal resulted by the external power supply, so as to increase the luminous stability of the LED. Additionally, the data strobe transistor of the compensation unit can not only control an input of the data signal but also control an on-off of the compensation unit so as to simplify the circuit structure and the circuit cost by utilizing a single transistor which can function for two transistors.

### BRIEF DESCRIPTION OF THE DRAWINGS

In order to more clearly illustrate the technical solution of the embodiments of the disclosure, the drawings of the embodiments will be briefly described in the following: it is obvious that the described drawings are only related to some embodiments of the disclosure, from which other drawings are easily conceivable for those skilled in the art without any inventive work.

FIG. 1 illustrates a most basic pixel circuit according to the existing technology;

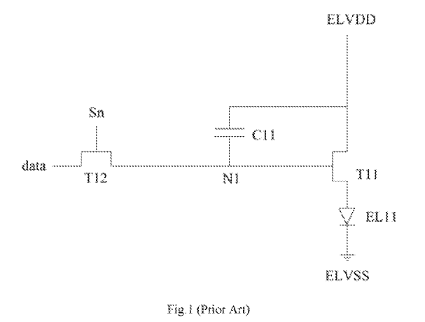

FIG. 2 illustrates a threshold compensation circuit according to the existing technology;

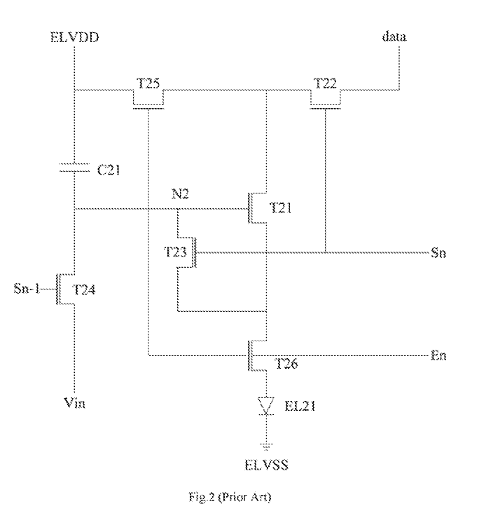

FIG. 3 is a schematic diagram illustrating an architecture of a pixel circuit provided by an embodiment of the present disclosure:

FIG. 4 is a schematic diagram illustrating an architecture of a pixel circuit with an initialization function provided by an embodiment of the present disclosure:

FIG. 5 is a schematic diagram illustrating a structure of an initialization unit provided by an embodiment of the present disclosure:

FIG. 6 is a schematic diagram illustrating a structure of a driving unit provided by an embodiment of the present disclosure;

FIG. 7 is a schematic diagram illustrating a structure of a driving unit provided by an embodiment of the present disclosure;

FIG. 8 is a flow chart illustrating a driving method of a pixel circuit provided by an embodiment of the present disclosure:

FIG. 9 is a schematic diagram illustrating a driving signal provided by an embodiment of the present disclosure;

FIG. 10 is a schematic diagram illustrating a driving signal provided by an embodiment of the present disclosure;

FIG. 11 illustrates one of feasible implementations of a pixel circuit provided by an embodiment of the present disclosure; and

FIG. 12 is a schematic diagram illustrating a structure of a display provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

An embodiment of the present disclosure provides a pixel circuit, including a compensation unit, a driving unit, a light-emitting unit, a capacitor and an external power supply. The compensation unit includes a data strobe transistor and a compensation transistor. In the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor; the gate electrode of the compensation transistor is electrically connected to the driving unit through a first node. The external power supply, the driving unit and the light-emitting unit are sequentially connected in series. The capacitor is located between the first node and the external power supply. The compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit. The capacitor is configured to maintain a voltage of the first node at the first voltage. The driving unit is externally connected to a first control signal and is configured to generate a driving current according to the first control signal so as to drive the light-emitting unit to emit light. The driving current is obtained according to the first voltage, the external power supply and a threshold voltage of a driving transistor in the driving unit. The driving transistor and the compensation transistor share a same gate electrode.

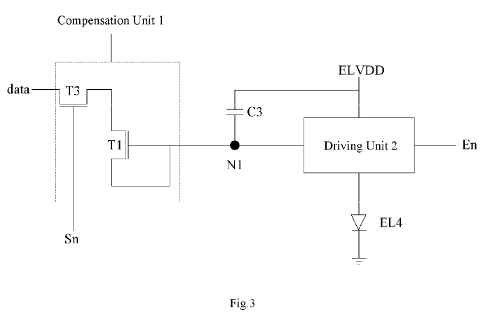

FIG. 3 is a schematic diagram illustrating architecture of a pixel circuit provided by an embodiment of the present disclosure. As illustrated in FIG. 3, the pixel circuit includes a compensation unit 1, a driving unit 2, a light-emitting unit EL4, a capacitor C3 and an external power supply ELVDD. The compensation unit 1 includes a data strobe transistor T3 and a compensation transistor T1. In the compensation unit 1, a first electrode of the data strobe transistor T3 is electrically connected to a second electrode of the compensation transistor T1; a second electrode of the data strobe transistor T3 is electrically connected to a data signal data; a gate electrode of the data strobe transistor T3 is electrically connected to a first scanning signal Sn; a first electrode of the compensation transistor T1 is electrically connected to a gate electrode of the compensation transistor T1; the gate electrode of the compensation transistor T1 is electrically connected to the driving unit 2 through a first node N1. The external power supply ELVDD, the driving unit 2 and the light-emitting unit EL4 are sequentially connected in series. The capacitor C3 is located between the first node N1 and the external power supply ELVDD. When the first scanning signal Sn controls the data strobe transistor T3 to be turned on, the compensation unit 1 is enabled, the compensation transistor T1 receives the data signal data and sets a voltage of the first node N1 to a first voltage, i.e., (V_{data}+V_{thT1}), wherein V_{thT1} indicates a threshold voltage of the compensation transistor T1. The capacitor C3 is configured to maintain a voltage of the first node N1 at the first voltage. The driving unit 2 is externally connected to a first control signal En. When the first control signal En controls the driving unit to be enabled, the driving unit generates a driving current so as to drive the light-emitting unit EL4 to emit light. The driving current is obtained according to the first voltage, the external power supply ELVDD and a threshold voltage of a driving transistor in the driving unit 2. As can be seen from the Equation 1, a magnitude of a driving current I_{EL4} flowing through the light-emitting unit EL4 in this case can be expressed by an Equation III as below:

$${I}_{EL 4} = \frac{1}{2} μ {C}_{OX} \frac{W}{L} {( {V}_{ELVDD} - {V}_{N 1} + {V}_{thT 2} )}^{2} , \qquad ( Equation III )$$

wherein V_{ELVDD} indicates a voltage of the external power supply ELVDD, V_{N1} indicates the first voltage, and V_{thT2} indicates the threshold voltage of the driving transistor. The driving transistor and the compensation transistor T1 share a same gate electrode, and hence have a same variation tendency in threshold voltage, that is, V_{thT1}−V_{thR2}=A, wherein A is a constant. As a result, the Equation III can be further converted to an Equation IV as below:

$${I}_{EL} = \frac{1}{2} μ {C}_{OX} \frac{W}{L} {( {V}_{ELVDD} - {V}_{data} - A )}^{2} . \qquad ( Equation IV )$$

In this way, the influence to the LED resulted by a threshold current of the driving transistor is eliminated. Moreover, in the pixel circuit as illustrated in FIG. 3, the data signal data is connected to the data strobe transistor T3 of the compensation unit 1, the power supply ELVDD is connected to the driving unit 2, so that during the data writing stage, the data signal data is written into the first node N1 by the compensation transistor T1, and during the light-emitting stage, ELVDD is connected to the driving unit 2, the data signal data and the external power supply ELVDD are isolated from each other to avoid the influence to the data signal data resulted by the external power supply ELVDD and improve the luminous stability of the LED. During specific implementation, an internal structure of the driving unit 2 is not particularly limited in the embodiments of the present disclosure, and all pixel circuits that satisfy the function(s) of the driving unit 2 and the interaction relationship(s) between the driving unit 2 and other structures of the pixel circuit as described in the foregoing embodiments shall be included in the embodiments of the present disclosure.

Optionally, the driving transistor and the compensation transistor are mirror transistors, both having a same threshold voltage, i.e., V_{thT1}=V_{thT2}. In this case, the Equation IV can be further simplified as a relational expression indicated by the Equation II.

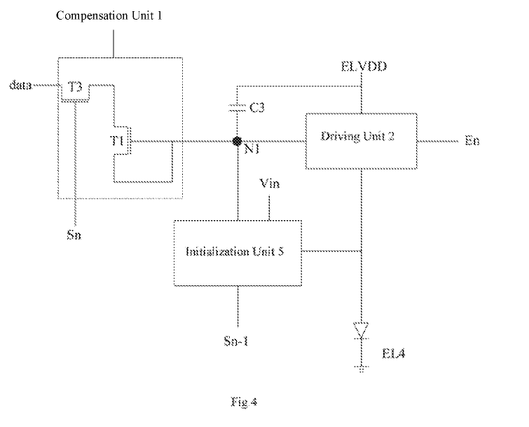

Optionally, the pixel circuit provided by the embodiments of the present disclosure can further include an initialization unit. FIG. 4 is a schematic diagram illustrating architecture of a pixel circuit with an initialization function provided by an embodiment of the present disclosure. As illustrated in FIG. 4, the initialization unit 5 is located between the first node N1 and the light-emitting unit EL4, and is externally connected to a second scanning signal Sn−1 and an initialization voltage Vin. When the second scanning signal Sn−1 enables the initialization unit, the initialization unit outputs the initialization voltage to the first node N1 and the light-emitting unit EL4, the capacitor C3 discharges until the voltage is decreased to Vin, so as to achieve initializing the first node N1 and the light-emitting unit EL4. The initialization process can discharge the voltage at N1 so as to ensure that, during the subsequent data writing stage, the data signal can be written into the node N1. An internal structure of the initialization unit 5 is not particularly limited in the embodiments of the present disclosure, and all pixel circuits that satisfy the function(s) of the initialization unit 5 and its interaction relationship(s) with the compensation unit 1 and the driving unit 2 as described in the foregoing embodiments shall be included in the embodiments of the present disclosure.

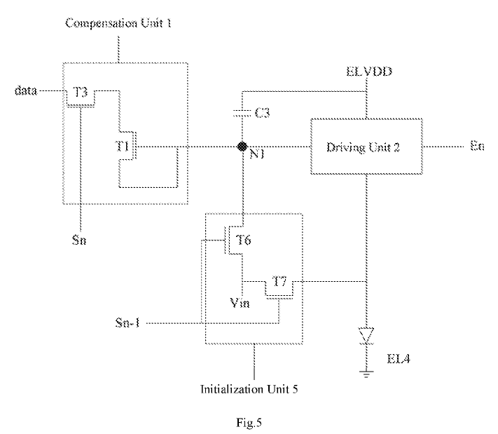

Optionally, the embodiment of the present disclosure provides a feasible implementation of the initialization unit. FIG. 5 is a schematic diagram illustrating a structure of an initialization unit provided by an embodiment of the present disclosure. As illustrated in FIG. 5, the initialization unit 5 includes a first initialization transistor T6 and a second initialization transistor T7. A first electrode of the first initialization transistor T6 is externally connected to an initialization voltage Vin; a second electrode of the first initialization transistor T6 is electrically connected to a first node N1; a gate electrode of the first initialization transistor T6 is electrically connected to a second scanning signal Sn−1; a first electrode of the second initialization transistor T7 is externally connected to the initialization voltage Vin; a second electrode of the second initialization transistor T7 is electrically connected to the light-emitting unit EL4; a gate electrode of the second initialization transistor T7 is electrically connected to the second scanning signal Sn−1. When the first initialization transistor T6 and the second initialization transistor T7 are turned on by the second scanning signal Sn−1, the initialization voltage is transmitted to the first node N1 through the first initialization transistor T6 so as to initialize the first node N1, and is transmitted to the light-emitting unit EL4 through the second initialization transistor 17 so as to initialize the light-emitting unit EL4. During specific implementation, Vin can be an individual initialization signal, and can also be the second scanning signal Sn−1. In the case where Vin is the second scanning signal, when the second scanning signal Sn−1 turns on the first initialization transistor T6 and the second initialization transistor T7, the first initialization transistor T6 and the second initialization transistor T7 are brought into a saturation state, the second scanning signal is transmitted to the first node N1 and to an anode of the light-emitting unit EL4, respectively, through the first initialization transistor T6 and the second initialization transistor T7, until the first initialization transistor T6 and the second initialization transistor T7 are cut off, so as to achieve the initialization of the first node N1 and the light-emitting unit EL4.

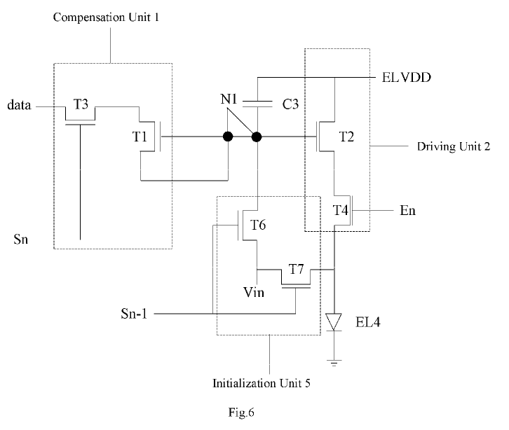

Optionally, the embodiment of the present disclosure provides a feasible implementation of a driving unit. FIG. 6 is a schematic diagram illustrating a structure of a driving unit provided by an embodiment of the present disclosure. As illustrated in FIG. 6, the driving unit 2 includes a driving transistor T2 and a light-emitting control transistor T4; a first electrode of the driving transistor T2 is externally connected to an external power supply ELVDD; a gate electrode of the driving transistor T2 is electrically connected to the compensation transistor T1; a second electrode of the driving transistor T2 is electrically connected to a first electrode of the light-emitting control transistor T4; a second electrode of the light-emitting control transistor T4 is electrically connected to the light-emitting unit EL4, and a gate electrode of the light-emitting control transistor T4 is externally connected to the first control signal En. When the light-emitting control transistor T4 is turned on by En, the driving transistor T2 generates a driving current according to a gate voltage and the external power supply ELVDD; the driving current is transmitted to the light-emitting unit EL4 through the light-emitting control transistor T4 and drives the light-emitting unit EL4 to emit light.

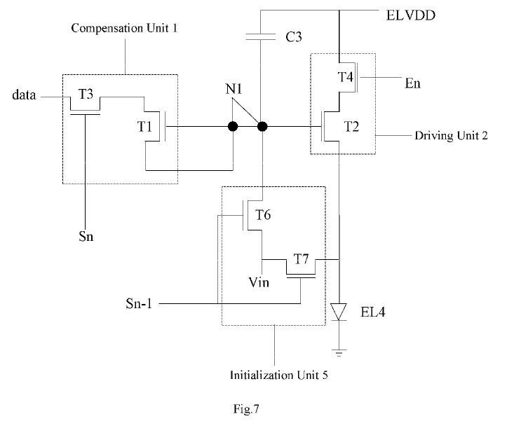

Optionally, the embodiment of the present disclosure further provides another feasible implementation of a driving unit. FIG. 7 is a schematic diagram illustrating a structure of a driving unit provided by an embodiment of the present disclosure. As illustrated in FIG. 7, the driving unit 2 includes a driving transistor T2 and a light-emitting control transistor T4; a first electrode of the light-emitting control transistor T4 is externally connected to an external power supply ELVDD; a second electrode of the light-emitting control transistor T4 is electrically connected to a first electrode of the driving transistor T2; a gate electrode of the light-emitting transistor T4 is externally connected to the first control signal En; a gate electrode of the driving transistor T2 is electrically connected to the compensation transistor T1; a second electrode of the driving transistor T2 is electrically connected to the light-emitting unit EL4. When the light-emitting control transistor T4 is turned on by En, the external power supply ELVDD is connected with the first electrode of the driving transistor T2 through the light-emitting control transistor T4, the driving transistor T2 generates a driving current according to a gate voltage and the external power supply, the driving current is transmitted to the light-emitting unit EL4 through the light-emitting control transistor T4 and drives the light-emitting unit EL4 to emit light.

To sum up, embodiments of the present disclosure provide a pixel circuit, a driving method and a display, including a compensation unit, a driving unit, a light-emitting unit, a capacitor and an external power supply. The compensation unit includes a data strobe transistor and a compensation transistor; in the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor; the gate electrode of the compensation transistor is electrically connected to the driving unit through a first node; the external power supply, the driving unit and the light-emitting unit are sequentially connected in series; the capacitor is located between the first node and the external power supply; the compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit; the capacitor is configured to maintain the voltage of the first node at the first voltage; the driving unit is externally connected to a first control signal and is configured to generate a driving current according to the first control signal so as to drive the light-emitting unit to emit light; the driving current is obtained according to the first voltage, the external power supply and a threshold voltage of a driving transistor in the driving unit; the driving transistor and the compensation transistor are configured to share a same gate electrode. The compensation unit is externally connected to the data signal, and the driving unit is externally connected to the external power supply, so that during the data writing stage, the data signal compensates for a threshold voltage of the compensation transistor of the compensation unit to increase the threshold voltage of the compensation transistor to a voltage of the data signal, so as to obtain the first voltage. The compensation unit is not externally connected to the external power supply, which avoids any influence to the data signal resulted by the external power supply. Furthermore, the driving transistor and the compensation transistor share a same gate electrode, and hence have a same variation tendency in threshold voltage; as a result, compensating for the threshold voltage of the compensation transistor as the voltage of the data signal is fairly equivalent to compensating for the threshold value of the driving transistor as the voltage of the data signal, thereby ensuring the threshold compensation function of the pixel circuit. Therefore, the embodiments of the present disclosure can achieve the threshold compensation function of the pixel circuit while preventing from any influence to the data signal resulted by the external power supply, so as to increase the luminous stability of the LED. Additionally, the data strobe transistor of the compensation unit can not only control an input of the data signal but also control an on-off of the compensation unit so as to simplify the circuit structure and the circuit cost by utilizing a single transistor which can function for two transistors.

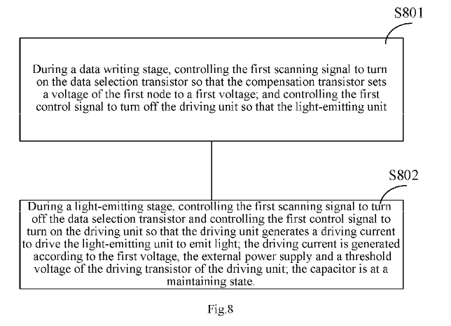

Based on the same technical conception, the embodiment of the present disclosure further provides a driving method of a pixel circuit, which is configured to drive the pixel circuit provided by the embodiments of the present disclosure. FIG. 8 is a flow chart illustrating a driving method of a pixel circuit provided by an embodiment of the present disclosure. As illustrated in FIG. 8, the driving method includes:

Step S801, during a data writing stage, controlling the first scanning signal to turn on the data strobe transistor so that the compensation transistor sets a voltage of the first node to a first voltage; and controlling the first control signal to turn off the driving unit so that the light-emitting unit doesn't emit light; maintaining the voltage of the first node at the first voltage by the capacitor, the first voltage is a voltage obtained upon compensating for a voltage of the data signal by the compensation transistor of the compensation unit:

Step S802, during a light-emitting stage, controlling the first scanning signal to turn off the data strobe transistor and controlling the first control signal to turn on the driving unit so that the driving unit generates a driving current to drive the light-emitting unit to emit light; the driving current is generated according to the first voltage, the external power supply and a threshold voltage of the driving transistor of the driving unit; the capacitor is at a maintaining state.

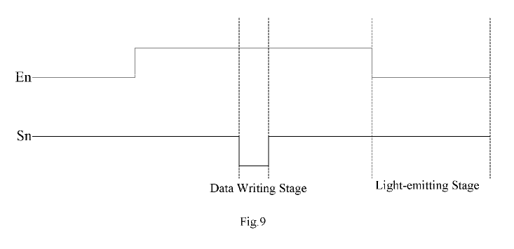

During specific implementation, the above-mentioned embodiment is capable of driving the pixel circuit as illustrated in FIG. 3. Optionally, by controlling the data strobe transistor T3 of the compensation unit 1 and also the transistor of the driving unit 2 to be turned on, it can achieve turning on or tuning off the compensation unit 1 and the driving unit 2. In such case, the pixel circuit as illustrated in FIG. 3 corresponds to a driving signal as illustrated in FIG. 9. FIG. 9 is a schematic diagram illustrating a driving signal provided by an embodiment of the present disclosure. The driving signal illustrated in FIG. 9 includes two types of signals, which are the first scanning signal Sn and the first control signal En. FIG. 9 also discloses a time sequence of the first scanning signal Sn and the first control signal En when the compensation unit 1 and the driving unit 2 in FIG. 3 both are a positive channel metal oxide semiconductor (PMOS).

During the data writing stage, as illustrated in FIG. 9, the first scanning signal Sn is at low level, the data strobe transistor T3 is turned on to enable the compensation unit 1, the first control signal is at high level, and the driving unit 2 is turned off. The compensation transistor T1 writes the data signal data into the first node N1, and the capacitor C3 starts charging until a voltage at the first node N1 is set as the first voltage(V_{data}+V_{thT1}). Afterwards, the compensation transistor T1 of the compensation unit 1 is cut off, and the capacitor C3 maintains the voltage of the first node N1 at the first voltage(V_{data}+V_{thT1}).

During the light-emitting stage, as illustrated in FIG. 9, the first scanning signal Sn is at high level, the data strobe transistor T3 is cut off, the compensation unit 1 is turned off, the first control signal is at low level, and the driving unit 2 is turned on. The driving unit 2 generates a driving current to drive the light-emitting unit EL4 to emit light. Since the voltage at the first node N1 is the first voltage(V_{data}+V_{thT1}), a threshold compensation can be achieved on the gate voltage of the driving transistor of the driving unit 2, so that the driving current is no longer influenced by the threshold drift of the driving transistor.

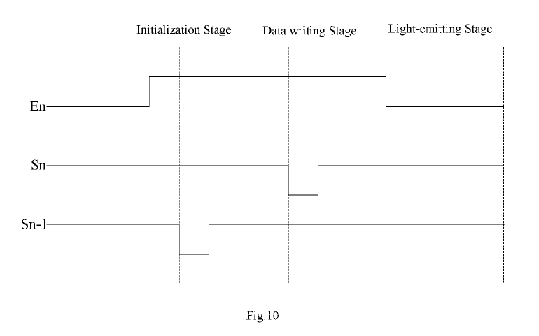

Corresponding to the pixel circuit as illustrated in FIG. 4, the embodiment of the present disclosure further provides another driving method of a pixel circuit. FIG. 10 is a schematic diagram illustrating a driving signal provided by an embodiment of the present disclosure. As illustrated in FIG. 10, the driving signal includes a first scanning signal Sn, a second scanning signal Sn−1 and a first control signal En. In addition, it further discloses a time sequence of the first scanning signal Sn, the second scanning signal Sn−1 and the first control signal En when the compensation unit 1, the driving unit 2 and the initialization unit 5 of the pixel circuit illustrated in FIG. 4 each are a PMOS transistor.

Prior to the data writing stage, the driving method should further include an initialization stage, including: controlling the second scanning signal Sn−1 to turn on the initialization unit 5, so that the initialization unit 5 initializes the first node N1 and the light-emitting unit EL4 by utilizing an initialization voltage Vin and the capacitor C3 maintains the initialization voltage Vin; controlling the first scanning signal Sn to cut off the data strobe transistor T3 so as to turn off the compensation unit 1, and controlling the first control signal En to turn off the driving unit 2.

During the data writing stage, as illustrated in FIG. 10, the first scanning signal Sn is at low level, the data strobe transistor T3 is turned on, the compensation unit 1 is enabled, the first control signal is at high level, and the driving unit 2 is turned off. The compensation transistor T1 writes the data signal data into the first node N1, and the capacitor C3 starts charging until a voltage at the first node N1 is set as the first voltage(V_{data}+V_{thT1}). Afterwards, the compensation transistor T1 is cut off, and the capacitor C3 maintains the voltage of the first node N at the first voltage(V_{data}+V_{thT1}).

During the light-emitting stage, as illustrated in FIG. 10, the first scanning signal Sn is at high level, the data strobe transistor T3 is cut off, the compensation unit 1 is turned off, the second scanning signal Sn−1 is at high level, the initialization unit is turned off, the first control signal En is at low level, and the driving unit 2 is enabled. The driving unit 2 generates a driving current to drive the light-emitting unit EL4 to emit light. Since the voltage at the first node N1 is the first voltage(V_{data}+V_{thT1}), a threshold compensation can be achieved on the gate voltage of the driving transistor of the driving unit 2 so that the driving current is no longer influenced by the threshold drift of the driving transistor.

In order to solve the problems in the existing technology that the luminance of the LED in the pixel circuit is not quite stable and the structure of the pixel circuit is complex, the embodiments of the present disclosure further optimize the existing threshold compensation circuit to avoid an influence to the data signal resulted by the external power supply, stabilize the luminance of the LED, and simplify the circuit by utilizing a single data strobe transistor which can function for two transistors. Hereinafter, several particular implementations are described with reference to PMOS, by way of example. It should be noted that, variants of the following particular implementations as well as NMOS or COMS circuits and driving methods thereof should also be fallen into the scope of protection of the embodiments of the present disclosure. The present disclosure is not intended to enumerate all the variants of pixel circuits but only to introduce some of the pixel circuits for purpose of explaining the technical solutions disclosed in the embodiments of the present disclosure.

### The First Embodiment

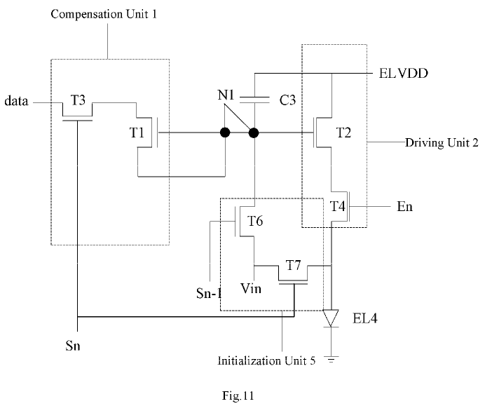

FIG. 11 illustrates one of feasible implementations of a pixel circuit provided by an embodiment of the present disclosure. As illustrated in FIG. 11, the compensation unit includes a data strobe transistor T3 and a compensation transistor T1; the driving unit includes a driving transistor T2 and a light-emitting control transistor T4; the initialization unit includes a first initialization transistor T6 and a second initialization transistor T7.

In the compensation unit 1, a drain electrode of the data strobe transistor T3 is electrically connected to a source electrode of the compensation transistor T1; a source electrode of the data strobe transistor T3 is electrically connected to a data signal data; a gate electrode of the data strobe transistor T3 is electrically connected to a first scanning signal Sn; a gate electrode of the compensation transistor T1 is electrically connected to a gate electrode the driving transistor T2 through a first node n1, a drain electrode of the compensation transistor T1 is electrically connected to the gate electrode of the compensation transistor T1.

In the driving unit 2, a source electrode of the driving transistor T2 is externally connected to an external power supply ELVDD; a drain electrode of the driving transistor T2 is electrically connected to a source electrode of the light-emitting control transistor T4; a drain electrode of the light-emitting control transistor T4 is electrically connected to the light-emitting unit EL4; a gate electrode of the light-emitting control transistor T4 is externally connected to a first control signal En.

In the initialization unit 5, a source electrode of the first initialization transistor T6 is externally connected to an initialization voltage Vin; a drain electrode of the first initialization transistor T6 is electrically connected to the first node N1; a gate electrode of the first initialization transistor T6 is electrically connected to a second scanning signal Sn−1; a source electrode of the second initialization transistor T7 is externally connected to the initialization voltage Vin; a drain electrode of the second initialization transistor T7 is electrically connected to the light-emitting unit EL4. Unlike that of the pixel circuit illustrated in FIG. 6 and FIG. 7, the gate electrode of the second initialization transistor T7 is electrically connected to the first scanning signal Sn so that the first initialization transistor T6 and the second initialization transistor T7 can be initialized at different time periods, which prevents the initialization voltage Vin from resulting in an excessively large instantaneous current and burning out the pixel circuit or a supply circuit providing a supply power to the pixel circuit.

The capacitor C3 is located between the first node N1 and the external power supply ELVDD.

According to the driving signal as illustrated in FIG. 10, a driving method of a pixel circuit as illustrated in FIG. 11 includes the following.

During an initialization stage, the first scanning signal Sn is at high level so that the data strobe transistor T3 is cut off, the compensation unit 1 is disenabled, and the second initialization transistor T7 is cut off. The first control signal En is at high level so that the light-emitting control transistor T4 is cut off, and the driving unit 2 is disenabled. The second control signal Sn−1 is at low level so that the first initialization transistor T6 is turned on; T6 transmits the initialization voltage to the first node N1 so as to initialize the first node N1.

During a data writing stage, the first scanning signal Sn is at low level so that the data strobe transistor T3 is turned on, and the compensation unit 1 is enabled. The first control signal En is at high level so that the light-emitting control transistor T4 is cut off and the driving unit 2 is disenabled. The second scanning signal Sn−1 is at high level so that the first initialization transistor T6 is cut off and the initialization unit 5 is disenabled. The data signal data arrives at the source electrode of the compensation transistor T1 through the data strobe transistor T3; due to a short circuit between the drain electrode and the gate electrode of the compensation transistor T1, the compensation transistor T1 is working at a saturation region, and the data signal data is written into the first node N1 until the voltage of the first node N1 reaches the first voltage (V_{data}+V_{thT1}), then the compensation transistor T1 is cut off. Since the first scanning signal Sn is at low level, the second initialization transistor T7 is turned on and transmits the initialization voltage Vin to the light-emitting unit EL4 so as to initialize the light-emitting unit EL4.

During a light-emitting stage, the first scanning signal Sn is at high level so that the data strobe transistor T3 is cut off, the compensation unit 1 is disenabled, and the second initialization transistor T7 is cut off. The first control signal En is at low level so that the light-emitting control transistor T4 is turned on, and the driving unit 2 is enabled. The second scanning signal Sn−1 is at high level so that the first initialization transistor T6 is cut off and the initialization unit 5 is disenabled. The driving transistor T2 generates a driving current to drive the light-emitting unit EL4 to emit light. Since the voltage at the first node N1 is the first voltage(V_{data}+V_{thT1}), a threshold compensation can be achieved on the gate voltage of the driving transistor so that the driving current is no longer influenced by the threshold drift of the driving transistor T2.

### The Second Embodiment

The embodiment of the present disclosure further provides a driving method of the pixel circuit as illustrated in FIG. 6. According to the driving signal as illustrated in FIG. 10, the driving method of the pixel circuit as illustrated in FIG. 6 includes the following.

During an initialization stage, the first scanning signal Sn is at high level so that the data strobe transistor T3 is cut off and the compensation unit 1 is disenabled. The first control signal En is at high level so that the light-emitting control transistor T4 is cut off and the driving unit 2 is disenabled. The second scanning signal Sn−1 is at low level so that the first initialization transistor T6 and the second initialization transistor T7 both are turned on; T6 transmits the initialization voltage to the first node N1 so as to initialize the first node N1; T7 transmits the initialization voltage Vin to the light-emitting unit EL4 so as to initialize the light-emitting unit EL4.

During a data writing stage, the first scanning signal Sn is at low level so that the data strobe transistor T3 is turned on and the compensation unit 1 is enabled. The first control signal En is at high level so that the light-emitting control transistor T4 is cut off and the driving unit 2 is disenabled. The second scanning signal Sn−1 is at high level so that the first initialization transistor T6 and the second initialization transistor T7 are cut off, and the initialization unit 5 is disenabled. The data signal data arrives at the source electrode of the compensation transistor T1 through the data strobe transistor T3; due to a short circuit between the drain electrode and the gate electrode of the compensation transistor T1, the compensation transistor T1 is working at a saturation region, and the data signal data is written into the first node N1 until the voltage at the first node N1 reaches the first voltage (V_{data}+V_{thT1}), then the compensation transistor T1 is cut off.

During a light-emitting stage, the first scanning signal Sn is at high level so that the data strobe transistor T3 is cut off and the compensation unit 1 is disenabled. The first control signal En is at low level so that the light-emitting control transistor T4 is turned on and the driving unit 2 is enabled. The second scanning signal Sn−1 is at high level so that the first initialization transistor T6 and the second initialization transistor T7 are cut off, and the initialization unit 5 is disenabled. The driving transistor T2 generates a driving current to drive the light-emitting unit EL4 to emit light. Since the voltage at the first node N1 is the first voltage(V_{data}+V_{thT1}), a threshold compensation can be achieved on the gate voltage of the driving transistor so that the driving current is no longer influenced by the threshold drift of the driving transistor T2.

In the first and second embodiments above, optionally, the first initialization transistor T6 and the second initialization transistor T7 of the initialization unit 5 can also be connected in such a manner that, the first electrode of the first initialization transistor T6 is electrically connected to the first node N1, the gate electrode of the first initialization transistor T6 is externally connected to the second scanning signal Sn−1, the second electrode of the first initialization transistor T6 is electrically connected to the light-emitting unit EL4, the first electrode of the second initialization transistor T7 is electrically connected to the light-emitting unit EL4, the second electrode of the second initialization transistor T7 is externally connected to the initialization voltage Vin, and the gate electrode of the second initialization transistor T7 is externally connected to the second scanning signal Sn−1. The first initialization transistor T6 and the second initialization transistor T7 are formed into a single, dual-gate transistor. By utilizing a single dual-gate transistor to replace the original transistors T6 and T7, the number of transistors used in the pixel circuit is reduced, and the circuit structure is simplified.

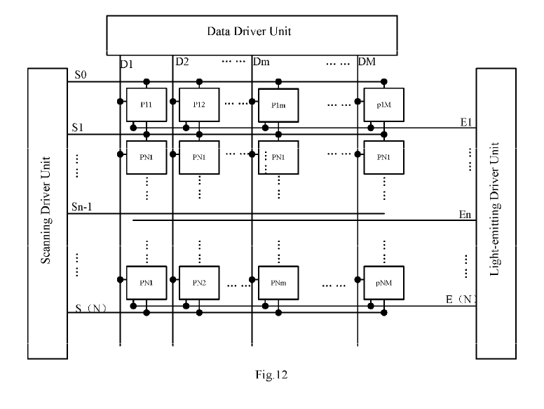

Based on the same technical conception, the embodiment of the present disclosure further provides a display adopting the pixel circuit provided by any of the foregoing embodiments. FIG. 12 is a schematic diagram illustrating a structure of a display provided by an embodiment of the present disclosure. As illustrated in FIG. 12, the display includes: a N×M array of pixel circuits; a scanning driver unit generating a scanning signal S0, S1, S2 . . . SN, wherein Sn is a scanning signal input into a n^{th} row of pixels by the scanning driver unit, n=1, 2, . . . N; a data driver unit generating total M data signals D1, D2 . . . DM corresponding to M columns of pixels, respectively, wherein Dm is the data signal data of a m^{th} column of pixels, m=1, 2, . . . M; a light-emitting driver unit generating a first control signal E1, E2 . . . EN, wherein En is the first control signal input into the n^{th} row of pixels by the light-emitting driver unit, n=1, 2, . . . N.

To sum up, embodiments of the present disclosure provide a pixel circuit, a driving method and a display, including a compensation unit, a driving unit, a light-emitting unit, a capacitor and an external power supply. The compensation unit includes a data strobe transistor and a compensation transistor; in the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor; the gate electrode of the compensation transistor is electrically connected to the driving unit through a first node; the external power supply, the driving unit and the light-emitting unit are sequentially connected in series; the capacitor is located between the first node and the external power supply; the compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit; the capacitor is configured to maintain the voltage of the first node at the first voltage; the driving unit is externally connected to a first control signal and is configured to generate a driving current according to the first control signal so as to drive the light-emitting unit to emit light; the driving current is obtained according to the first voltage, the external power supply and a threshold voltage of a driving transistor in the driving unit; the driving transistor and the compensation transistor are configured to share a same gate electrode. The compensation unit is externally connected to the data signal, and the driving unit is externally connected to the external power supply, so that during the data writing stage, the data signal compensates for a threshold voltage of the compensation transistor of the compensation unit to increase the threshold voltage of the compensation transistor to a voltage of the data signal, so as to obtain the first voltage. The compensation unit is not externally connected to the external power supply, which avoids any influence to the data signal resulted by the external power supply. Furthermore, the driving transistor and the compensation transistor share a same gate electrode, and hence have a same variation tendency in threshold voltage; as a result, compensating for the threshold voltage of the compensation transistor as the voltage of the data signal is fairly equivalent to compensating for the threshold value of the driving transistor as the voltage of the data signal, thereby ensuring the threshold compensation function of the pixel circuit. Therefore, the embodiments of the present disclosure can achieve the threshold compensation function of the pixel circuit while preventing from any influence to the data signal resulted by the external power supply, so as to increase the luminous stability of the LED. Additionally, the data strobe transistor of the compensation unit can not only control an input of the data signal but also control an on-off of the compensation unit so as to simplify the circuit structure and the circuit cost by utilizing a single transistor which can function for two transistors.

Although preferred embodiments of the present disclosure have been described, those skilled in the art should be appreciated that, other modifications and variants may be made to these embodiments upon learning the basic inventive conception. Therefore, the appended claims are intended to be interpreted as encompassing the preferred embodiments and all the modifications and variants which are fallen into the scope of the present disclosure.

Obviously, various modifications and variants may be made to the present disclosure by those skilled in the art without departing from the spirit and scope of the present disclosure. In this way, the present disclosure is intended to encompass these alternations and modifications which are pertaining to the scope of the claims of the present disclosure and the equivalents thereof.

What is claimed is:

1. A pixel circuit, comprising a compensation unit, a driving unit, a light-emitting unit, a capacitor and an external power supply, wherein the compensation unit comprises a data strobe transistor and a compensation transistor,
in the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor, the gate electrode of the compensation transistor is electrically connected to the driving unit through a first node; the external power supply, the driving unit and the light-emitting unit are sequentially connected in series; the capacitor is located between the first node and the external power supply,
the compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit,
the capacitor is configured to maintain the voltage of the first node at the first voltage, and
the driving unit is externally connected to a first control signal and is configured to generate a driving current according to the first control signal so as to drive the light-emitting unit to emit light; the driving current is obtained according to the first voltage, the external power supply and a threshold voltage of a driving transistor in the driving unit; the driving transistor and the compensation transistor are configured to share a same gate electrode.

2. The pixel circuit according to claim 1, wherein the driving transistor and the compensation transistor are mirror transistors.

3. The pixel circuit according to claim 1, further comprising an initialization unit, wherein
the initialization unit is located between the first node and the light-emitting unit; the initialization unit is externally connected to a second scanning signal and an initialization voltage, and
the initialization unit is configured to initialize the first node and the light-emitting unit by utilizing the initialization voltage, under a control of the second scanning signal.

4. The pixel circuit according to claim 3, wherein the initialization unit comprises a first initialization transistor and a second initialization transistor,
a first electrode of the first initialization transistor is externally connected to the initialization voltage; a second electrode of the first initialization transistor is electrically connected to the first node; a gate electrode of the first initialization transistor is electrically connected to the second scanning signal, and
a first electrode of the second initialization transistor is externally connected to the initialization voltage; a second electrode of the second initialization transistor is electrically connected to the light-emitting unit; a gate electrode of the second initialization transistor is electrically connected to the second scanning signal.

5. The pixel circuit according to claim 1, wherein the driving unit comprises a driving transistor and a light-emitting control transistor,
a first electrode of the driving transistor is externally connected to the external power supply; a gate electrode of the driving transistor is electrically connected to the compensation unit; a second electrode of the driving transistor is electrically connected to a first electrode of the light-emitting control transistor, and
a second electrode of the light-emitting control transistor is electrically connected to the light-emitting unit, and a gate electrode of the light-emitting control transistor is externally connected to the first control signal.

6. The pixel circuit according to claim 1, wherein the driving unit comprises a driving transistor and a light-emitting control transistor,
a first electrode of the light-emitting control transistor is externally connected to the external power supply; a second electrode of the light-emitting control transistor is electrically connected to a first electrode of the driving transistor, a gate electrode of the light-emitting control transistor is externally connected to the first control signal, and
a gate electrode of the driving transistor is electrically connected to the compensation unit; a second electrode of the driving transistor is electrically connected to the light-emitting unit.

7. A driving method of a pixel circuit, applied in a pixel circuit, the pixel circuit comprising a compensation unit, a driving unit, a light-emitting unit, a capacitor and an external power supply, wherein the compensation unit comprises a data strobe transistor and a compensation transistor,
in the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor, the gate electrode of the compensation transistor is electrically connected to the driving unit through a first node; the external power supply, the driving unit and the light-emitting unit are sequentially connected in series; the capacitor is located between the first node and the external power supply,
the compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit,
the capacitor is configured to maintain the voltage of the first node at the first voltage, and
the driving unit is externally connected to a first control signal and is configured to generate a driving current according to the first control signal so as to drive the light-emitting unit to emit light; the driving current is obtained according to the first voltage, the external power supply and a threshold voltage of a driving transistor in the driving unit; the driving transistor and the compensation transistor are configured to share a same gate electrode,
the driving method comprising:
during a data writing stage, controlling the first scanning signal to turn on the data strobe transistor so that the compensation transistor sets a voltage of the first node to the first voltage; and controlling the first control signal to turn off the driving unit so that the light-emitting unit doesn't emit light; maintaining a voltage of the first node at the first voltage by the capacitor, the first voltage being a voltage obtained upon compensating for a voltage of the data signal by the compensation transistor of the compensation unit; and
during a light-emitting stage, controlling the first scanning signal to turn off the data strobe transistor and controlling the first control signal to turn on the driving unit so that the driving unit generates a driving current to drive the light-emitting unit to emit light; the driving current being generated according to the first voltage, the external power supply and a threshold voltage of a driving transistor of the driving unit; the capacitor being at a maintaining state.

8. The driving method according to claim 7, further comprising: before the data writing stage,
during an initialization stage, controlling the second scanning signal to turn on an initialization unit which is located between the first node and the light-emitting unit and is externally connected to a second scanning signal and an initialization voltage, so that the initialization unit initializes the first node and the light-emitting unit by utilizing an initialization voltage and the capacitor maintains the initialization voltage; controlling the first scanning signal to turn off the data strobe transistor and controlling the first control signal to turn off the driving unit.

9. The driving method according to claim 8, further comprising:
during the data writing stage, controlling the second scanning signal to turn off the initialization unit; and
during the light-emitting stage, controlling the second scanning signal to turn off the initialization unit.

10. A display comprising a pixel circuit, the pixel circuit comprising a compensation unit, a driving unit, a light-emitting unit, a capacitor and an external power supply, wherein the compensation unit comprises a data strobe transistor and a compensation transistor,
in the compensation unit, a first electrode of the data strobe transistor is electrically connected to a second electrode of the compensation transistor; a second electrode of the data strobe transistor is electrically connected to a data signal; a gate electrode of the data strobe transistor is electrically connected to a first scanning signal; a first electrode of the compensation transistor is electrically connected to a gate electrode of the compensation transistor, the gate electrode of the compensation transistor is electrically connected to the driving unit through a first node; the external power supply, the driving unit and the light-emitting unit are sequentially connected in series; the capacitor is located between the first node and the external power supply,
the compensation unit is configured to turn on the data strobe transistor by the first scanning signal so that the compensation transistor sets a voltage of the first node to a first voltage, the first voltage is a voltage obtained upon compensating for a voltage of the data signal by the compensation transistor of the compensation unit,
the capacitor is configured to maintain the voltage of the first node at the first voltage, and
the driving unit is externally connected to a first control signal and is configured to generate a driving current according to the first control signal so as to drive the light-emitting unit to emit light; the driving current is obtained according to the first voltage, the external power supply and a threshold voltage of a driving transistor in the driving unit; the driving transistor and the compensation transistor are configured to share a same gate electrode.

11. The display according to claim 10, wherein the driving transistor and the compensation transistor are mirror transistors.

12. The display according to claim 10, further comprising an initialization unit, wherein
the initialization unit is located between the first node and the light-emitting unit; the initialization unit is externally connected to a second scanning signal and an initialization voltage, and
the initialization unit is configured to initialize the first node and the light-emitting unit by utilizing the initialization voltage, under a control of the second scanning signal.

13. The display according to claim 12, wherein the initialization unit comprises a first initialization transistor and a second initialization transistor,
a first electrode of the first initialization transistor is externally connected to the initialization voltage; a second electrode of the first initialization transistor is electrically connected to the first node; a gate electrode of the first initialization transistor is electrically connected to the second scanning signal, and
a first electrode of the second initialization transistor is externally connected to the initialization voltage; a second electrode of the second initialization transistor is electrically connected to the light-emitting unit; a gate electrode of the second initialization transistor is electrically connected to the second scanning signal.

14. The display according to claim 10, wherein the driving unit comprises a driving transistor and a light-emitting control transistor,
a first electrode of the driving transistor is externally connected to the external power supply; a gate electrode of the driving transistor is electrically connected to the compensation unit; a second electrode of the driving transistor is electrically connected to a first electrode of the light-emitting control transistor, and
a second electrode of the light-emitting control transistor is electrically connected to the light-emitting unit, and a gate electrode of the light-emitting control transistor is externally connected to the first control signal.

15. The display according to claim 10, wherein the driving unit comprises a driving transistor and a light-emitting control transistor,
a first electrode of the light-emitting control transistor is externally connected to the external power supply; a second electrode of the light-emitting control transistor is electrically connected to a first electrode of the driving transistor, a gate electrode of the light-emitting control transistor is externally connected to the first control signal, and
a gate electrode of the driving transistor is electrically connected to the compensation unit; a second electrode of the driving transistor is electrically connected to the light-emitting unit.
